(19) United States
(12) Patent Application Publication
(10) Pub. No.: US 2009/0218035 A1
(43) Pub. Date: Sep. 3, 2009

(54) ROLLER FOR APPLYING CONTACT PRESSURE ONTO SHEETS OF MATERIAL

(75) Inventors: Christian Malterer, Augsburg (DE); Thomas Roessle, Gersthofen - Batzenhofen (DE)

Correspondence Address: FISH & RICHARDSON PC, P.O. BOX 1022, MINNEAPOLIS, MN, 55440-1022, US

(73) Assignee: Texmag GmbH Vertriebsgesellschaft, Thalwil (CH)

(21) Appl. No.: 12/364,139

(22) Filed: Feb. 2, 2009

Related U.S. Application Data
(60) Provisional application No. 61/028,713, filed on Feb. 14, 2008.

(30) Foreign Application Priority Data
Feb. 5, 2008 (EP) EP08151055.4

(51) Int. Cl. B29C 43/46; F16C 13/00

(52) U.S. Cl. 156/110.1; 492/40; 492/6; 156/421.6

(57) ABSTRACT

This application relates to rollers that may be used to apply pressure onto one or more sheets of material.

### CROSS-REFERENCE TO RELATED APPLICATIONS

This application claims priority under 35 U.S.C. § 119 to European Patent Application No. EP08151055.4, filed Feb. 5, 2008, the contents of which are hereby incorporated by reference in its entirety, and under 35 U.S.C. § 119 to U.S. Provisional Patent Application No. 61/028,713, filed on Feb. 14, 2008, the contents of which are hereby incorporated by reference in its entirety.

### FIELD OF APPLICATION

This application relates to rollers that may be used to apply pressure onto one or more sheets of material.

### BACKGROUND

In the production of tires, materials are joined together. For this purpose, one sheet of rubber is pressed onto another sheet of rubber with the appropriate pressure. This causes the sheets to be permanently joined together. Often, the sheets to be joined together are not level. As a result, a narrow strip must regularly be joined to a very much wider sheet. The required pressure is created by laminator rolls. Known are laminator rolls where multiple individual disks are mounted to a shaft.

A schematic three-dimensional sectional view of such known laminator roll is shown in FIG. 1. Shown are multiple disks mounted to a shaft. Each disk is coated with a non-stick material and the disks are able to freely rotate independently from each other on the shaft. Each disk has furthermore a hole at the center, which is clearly larger than the diameter of the shaft, allowing each individual disk to move in radial direction away from the shaft. Due to the fact that the individual disks of the laminator roll can change their position in relation to each other, the laminator roll can adjust to the surface contour of the material sheets to be joined.

### SUMMARY

This document discloses rollers and their use for the application of contact pressure to one or multiple sheets of material.

According to one aspect, a roller for the application of contact pressure to one or multiple sheets of material exhibits a roller shaft on which a plurality of disks are arranged. The disks are moveable in radial direction and exert contact pressure to the one or multiple sheets of material. The contact pressure of the disks can be applied or controlled pneumatically or hydraulically.

The contact pressure of the disks can be controlled via an internal pressure inside the roller. The pressure inside the roller can be directed at the disks in a certain direction in space. In a certain direction in space means that the disks may generally be forced into one general direction. The direction may be against the sheets of material, and may be independent of gravity.

In some embodiments, the roller shaft is hollow and exhibits a recess, allowing the contact pressure of the disks to be controlled via the internal pressure in an inner roller shaft body which is arranged inside the roller shaft. This device may include a tube and a separating layer with the separating layer enclosing the tube and being located between the tube and the disks. The separating layer may be tube-shaped and/or may be attached directly to the tube.

In some embodiments, the separating layer may be at least partially made of flexible metal. The separating layer may be made of a comb plate made of spring steel or may be made out of foil. The tube may be closed at each end by a plug.

In various embodiments, the roller may exhibit one or more of the following characteristics. The pressure inside the tube may be controlled with a valve located inside one of the plugs. The disks may be secured on the shaft by a retaining collar on each side. The disks may have a non-stick coating. The contact pressure can furthermore be adjusted on the fly during operation by changing the internal pressure of the device inside the roller. In certain embodiments, an electronic fine pressure valve is available to attempt to match the internal pressure of the device inside the roller precisely to production process parameters.

This type of roller can be used for the lamination of sheets of material. In some embodiments, the roller may be used for the laminating process in the production of tires.

Certain embodiments may exhibit one or more of the following example advantages. The contact pressure being applied by the roller to the materials to be joined can be controlled via the pressure inside the shaft. As a result, the roller may be used for a large number of different applications without the need to change the design. The contact pressure of the roller can be adjusted on the fly. Through the cutout on one side of the shaft, the pressure is directly transmitted from the inside of the shaft to the individual disks. The internal pressure inside the roller can be controlled pneumatically or hydraulically. In some embodiments, this may mean that significantly lighter disks or disks with smaller dimensions may be used to provide the contact pressure. Therefore, it may be possible to use significantly more cost-efficient disks. Disks may be less likely to stick together and therefore may be less likely to apply uneven pressure.

### BRIEF DESCRIPTION OF THE DRAWINGS

Following is an explanation based on example embodiments with reference to the attached drawings.

FIG. 1 is a three-dimensional view of a known laminator roller;

FIG. 2 is a three-dimensional exploded view of a roller;

FIG. 3 is a three-dimensional view of the roller from FIG. 2;

FIG. 4 is a three-dimensional front view of a roller;

FIG. 5 is a schematic sectional view along line B-B from FIG. 4:

FIG. 6 is a schematic lateral view of a roller;

FIG. 7 is a schematic sectional view along line A-A from FIG. 6.

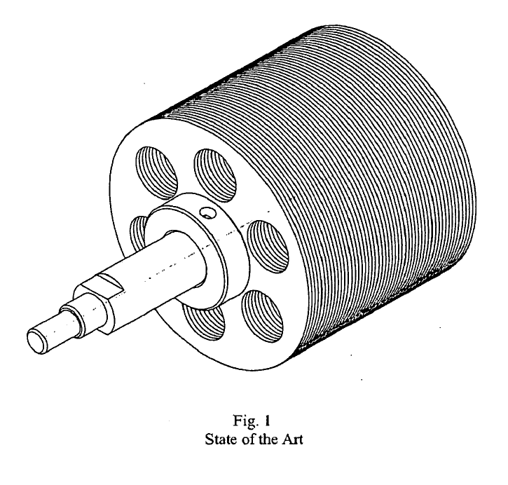

### DETAILED DESCRIPTION

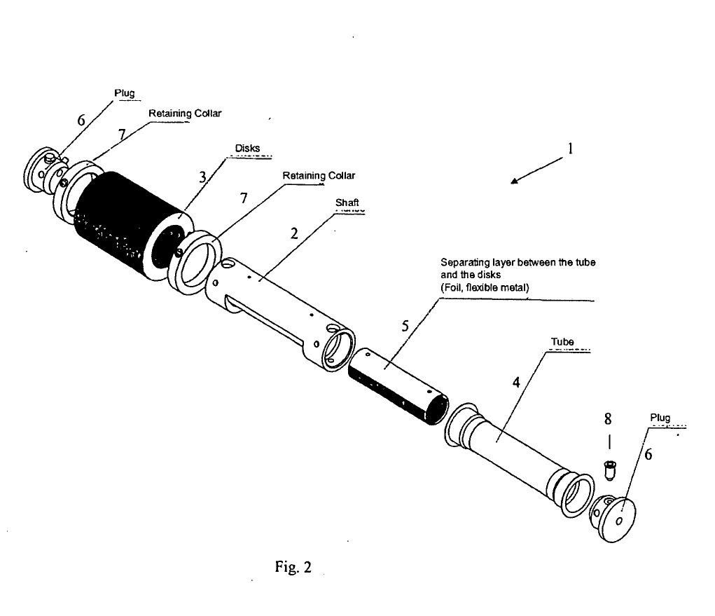

FIG. 2 shows an example embodiment of a roller 1. The roller one may be used to apply contact pressure onto one or more sheets of material. This exploded view will be used to explain a possible design option and operating method.

In FIG. 2, the shaft 2 is hollow. The shaft 2 exhibits a cutout in the downward direction. A separating layer 5 is inserted into the shaft 2 and there attached. A tube 4 is positioned inside of the shaft 2 in such manner that the separating layer 5 is located between the shaft 2 and tube 4. The separating layer 5 can also serve as protection of the tube 4. It is also used for the transmission of the force from the tube 4 to the disks 3.

The separating layer 5 can be made at least partially of flexible metal or a foil. In certain embodiments, the separating layer 5 may include a spring steel comb plate transmitting the force from the tube 4 to the disks 3. Such a spring steel comb plate allows the transmission of an additional, predefined force to the individual disks 3 according to their radial position.

The ends of the tube 4 are closed with plugs 6. In some embodiments, at least one of the plugs 6 may exhibit a valve 8. The valve 8 can be used to adjust the internal pressure inside the tube 4. The plugs 6 may exhibit on their outer front sides recesses or projections, to which the shaft 1 can be attached.

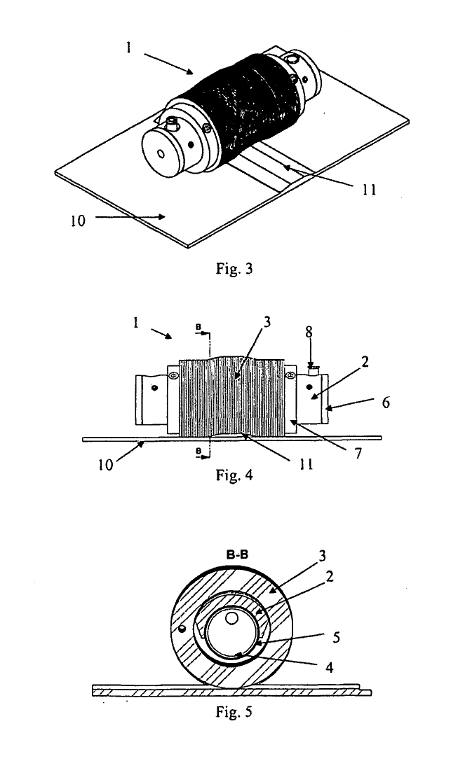

Individual disks 3 are pushed onto the shaft 2. The disks 3 are able to rotate around the fixed shaft 2. In certain embodiments, the complete roller 1 and shaft 2 are assembled in such manner that the shaft 2 is fixed so that during operation only the disks 3 rotate around the shaft 2. On the sides, the disks 3 can be secured by retaining collars 7 to maintain their lateral position of the shaft 2. The thickness of the disks 3 is selected depending on the application. The diameters of the holes in the disks 3 may be matched to the outer diameter of the shaft 2 in such manner that the disks 3 can be moved in radial direction in reference to the shaft 2. This allows the disks 3 to adjust to the surface contour of one or more sheets of material. This is further illustrated in FIG. 3 and FIG. 4.

FIG. 3 shows a three-dimensional view of roller 1 in combination with two sheets of material 10, 11. Both sheets of material can be a rubber-like material, for example. In order to join the sheets together using contact pressure, a roller 1 according to one of the embodiments described herein can be used. The laminating step for the materials 10, 11 may include the additional use of glue. The process may also be performed with the application of heat. The rollers described herein are in no way limited to applications for the joining or laminating of rubber-type materials. The rollers may also be used in other processes, where pressure is applied by a roller 1.

FIG. 3 also indicates that the disks 3 can shifted along the radial direction of the shaft 2 in such manner that they will adjust to the surface contour of the sheets of material 10, 11. In this example, the inner disks of the roller 1 have been shifted to the top. The inclines of the material 11 are also matched by the disks 3.

FIG. 4 shows a front view of an example roller 1. Due to the material 11, the disks 3 located above this sheet of material are shifted upwards in order to match the surface contour of the materials 10, 11. The shaft 2 including plugs 6 and valve 8 is also shown, as are the retaining collars 7. In an example embodiment, the shaft 2 has an outer diameter of 42 mm while the outer diameter of the disks 3 is 66 mm. These dimensions are only examples and may be selected according to the desired application.

FIG. 5 shows a sectional view along line B-B from FIG. 4. It indicates the architecture of the shaft 2 and the tube 4, the separating layer 5 and the disks 3 according to one embodiment. The shaft 2 exhibits a downward cutout to allow the force from the tube 4 to be transmitted to the disks 3 via the separating layer 5. In this example, almost the entire semi-segment of the shaft 2 has been cut out. As shown in this example, the shaft 2 can exhibit a flattening towards the cutout. In instances where the outer diameter of the shaft 2 and the inner diameter of the disks 3 are similar and the shaft 2 is nearly a semi-circular segment or more, such a design may permit the disks 3 as shown in FIG. 5 to be able to shift in vertical direction in reference to the shaft 2. The movement of the disks 3 in the radial direction, which in FIG. 5 is also the vertical direction, generally is permitted by the design of the roller and in particular by matching the shaft 2 to the disks 3. The example shown here is only one of many ways to achieve this condition.

Via the separating layer 5 which, for example, can be made of flexible metal, the force generated by the internal pressure of the tube 4 is transmitted to the disks 3. However, in the example shown here, the internal pressure of the tube 4 is so low that the separating layer 5 is not pressed against the disks 3 yet. If, for example, the shaft 2 of the roller 1 would be lowered, the separating layer 5 would come in contact with the disks 3. Depending on how the contact pressure shall vary from disk to disk, different materials and/or designs can be selected for the separating layer 5. For example, foils or metals with different thicknesses and different elasticity can be used. Spring steel comb plates can be used in order to increase the reset force for each disk via the separating layer 5.

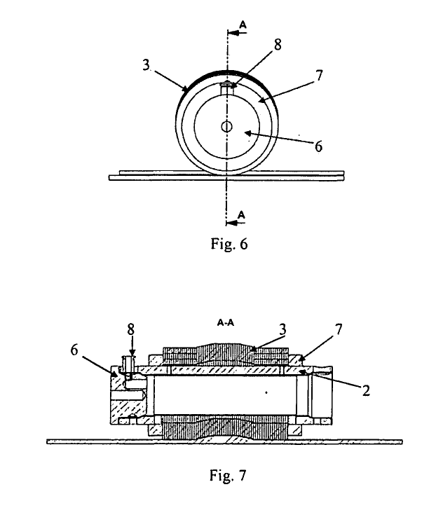

FIG. 6 shows an example of a lateral view. It indicates the front side with a plug 6 and a valve 8. Also included are a retaining collar 7 and the disks 3. In this embodiment, the plug 7 exhibits a hole in the center, which is used to support or mount the roller. In this embodiment, the shaft 2 may be fixed and only the disks 3 may rotate freely.

FIG. 7 shows a schematic view along the line A-A of FIG. 6. FIG. 7 indicates how the internal pressure of the roller can be controlled via the valve 8 and an opening in the plug 6. The cutout in shaft 2 on the underside can also be seen. As in FIG. 5, the internal pressure of the roller of FIG. 7 is not high enough or the roller shaft is so high above the material that the separating layer does not apply any force yet on the disks 3.

What is claimed is:

1. A device, comprising:
a roller shaft; and
disks arranged around the roller shaft, the disks being movable in a radial direction of the roller shaft, wherein when the disks contact a sheet of material during use of the device, the disks apply a contact pressure to the sheet that can be controlled at least one of pneumatically or hydraulically; and wherein the device is a roller.

2. The device of claim 1, wherein the contact pressure is capable of laminating the sheet to one or more other sheets of material.

3. The device of claim 1, wherein the contact pressure is capable of being controlled via an internal pressure inside the device.

4. The device of claim 3, wherein the internal pressure acts in the radial direction.

5. The device of claim 4, wherein the roller shaft is hollow and has a recess.

6. The device of claim 5, further comprising:
an inner roller shaft body arranged inside the roller shaft, wherein the hollow roller shaft and the recess of the roller shaft allow the contact pressure to be controlled via the internal pressure, the internal pressure being in the inner roller shaft body.

7. The device of claim 6, wherein the inner roller shaft body comprises:
a tube; and
a separating layer that encloses the tube and that is located between the tube and the disks.

8. The device of claim 7, wherein the separating layer is tube-shaped and is attached directly to the tube.

9. The device of claim 7, wherein the separating layer at least partially comprises a flexible metal.

10. The device of claim 9, wherein the separating layer comprises a comb plate, the comb plate being made of at least one of spring steel or foil.

11. The device of claim 7, wherein the tube has a first end and a second end, the tube being closed at the first end by a first plug and being closed at the second end by a second plug.

12. The device of claim 11, wherein the internal pressure is in the tube and is capable of being controlled with a valve located inside the first plug.

13. The device of claim 1, wherein the disks are secured on the roller shaft by retaining collars.

14. The device of claim 1, wherein the disks have a non-stick coating.

15. The device of claim 6, wherein the contact pressure is capable of being adjusted during operation by changing the internal pressure in the inner roller shaft body.

16. A method, comprising:
laminating one or more sheets of material using a device, the device comprising:
a roller shaft; and
disks arranged around the roller shaft, the disks being movable in a radial direction of the roller shaft, wherein when the disks contact a sheet of material during use of the device, the disks apply a contact pressure to the sheet that can be controlled at least one of pneumatically or hydraulically; and wherein the device is a roller.

17. The method of claim 16, wherein the method produces a tire.

18. A device, comprising:
a roller shaft, the roller shaft being hollow and having a recess;
an inner roller shaft body arranged inside the roller shaft; and
disks arranged around the roller shaft, the disks being movable in a radial direction of the roller shaft, wherein when the disks contact a sheet of material during use of the device, the disks apply a contact pressure to the sheet that can be controlled at least one of pneumatically or hydraulically, wherein the hollow roller shaft and the recess of the roller shaft allow the contact pressure to be controlled via an internal pressure inside the inner roller shaft body, and wherein the device is a roller.

19. The device of claim 18, wherein the inner roller shaft body comprises:
a tube; and
a separating layer that encloses the tube and that is located between the tube and the disks.

20. The device of claim 19, wherein the tube has a first end and a second end, the tube being closed at the first end by a first plug and being closed at the second end by a second plug; and
wherein the internal pressure is in the tube and is capable of being controlled with a valve located inside the first plug.
